(19) United States
(12) Patent Application Publication
(10) Pub. No.: US 2022/0392087 A1
(43) Pub. Date: Dec. 8, 2022

(54) SYSTEMS AND METHODS FOR REGISTERING AN INSTRUMENT TO AN IMAGE USING POINT CLOUD DATA

(71) Applicant: INTUITIVE SURGICAL OPERATIONS, INC., Sunnyvale, CA (US)

(72) Inventors: Federico Barbagli, San Francisco, CA (US); Troy K. Adebar, San Jose, CA (US); Sungwon Yoon, Palo Alto, CA (US); Hui Zhang, San Jose, CA (US); Tao Zhao, Sunnyvale, CA (US)

(21) Appl. No.: 17/774,822

(22) PCT Filed: Nov. 5, 2020
(86) PCT No.: PCT/US2020/059037

§ 371 Date: May 5, 2022

Related U.S. Application Data
(60) Provisional application No. 62/932,965, filed on Nov. 8, 2019.

(51) Int. Cl. G06T 7/33; G06T 7/11; G06V 10/25; G06T 7/00

(52) U.S. Cl. CPC G06T 7/33; G06T 7/11; G06V 10/25; G06T 7/0012; G06T 2207/20092; G06T 2207/30004; G06V 2201/034

(57) ABSTRACT

A system may comprise a processor and a memory having computer readable instructions stored thereon. The computer readable instructions, when executed by the processor, may cause the system to record shape data from a shape sensor for an instrument during an image capture period and generate a sensor point cloud from the recorded shape data. The computer readable instructions, when executed by the processor, may also cause the system to receive image data from an imaging system during the image capture period, generate an image point cloud for the instrument from the image data, and register the sensor point cloud to the image point cloud.

### CROSS-REFERENCE TO RELATED APPLICATIONS

This application claims the benefit of U.S. Provisional Application 62/932,965 filed Nov. 8, 2019, which is incorporated by reference herein in its entirety.

### FIELD

The present disclosure is directed to systems and methods for registering instrument and image frames of reference.

### BACKGROUND

Minimally invasive medical techniques are intended to reduce the amount of tissue that is damaged during medical procedures, thereby reducing patient recovery time, discomfort, and harmful side effects. Such minimally invasive techniques may be performed through natural orifices in a patient anatomy or through one or more surgical incisions. Through these natural orifices or incisions, an operator may insert minimally invasive medical tools to reach a target tissue location. Minimally invasive medical tools include instruments such as therapeutic, diagnostic, biopsy, and surgical instruments. Medical tools may be inserted into anatomic passageways and navigated toward a region of interest within a patient anatomy. Navigation may be assisted using images of the anatomic passageways. Improved systems and methods are needed to accurately perform registrations between medical tools and images of the anatomic passageways.

### SUMMARY

Consistent with some embodiments, a system may comprise a processor and a memory having computer readable instructions stored thereon. The computer readable instructions, when executed by the processor, may cause the system to record shape data from a shape sensor for an instrument during an image capture period and generate a sensor point cloud from the recorded shape data. The computer readable instructions, when executed by the processor, may also cause the system to receive image data from an imaging system during the image capture period, generate an image point cloud for the instrument from the image data, and register the sensor point cloud to the image point cloud.

Consistent with some embodiments, a non-transitory machine-readable medium may comprise a plurality of machine-readable instructions which when executed by one or more processors associated with a computer-assisted medical system device are adapted to cause the one or more processors to perform a method that may comprise recording shape data from a shape sensor for an instrument during an image capture period and generating a sensor point cloud from the recorded shape data. The performed method may further comprise receiving image data from an imaging system during the image capture period, generating an image point cloud for the instrument from the image data, and registering the sensor point cloud to the image point cloud.

Other embodiments include corresponding computer systems, apparatus, and computer programs recorded on one or more computer storage devices, each configured to perform the actions of the methods.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTIONS OF THE DRAWINGS

FIG. 1 illustrates a simplified diagram of a robotic or teleoperated medical system according to some embodiments.

FIG. 2 illustrates a simplified diagram of a medical instrument system and an intraoperative imaging system according to some embodiments.

FIG. 3 illustrates a display system displaying an image of a medical instrument registered to an anatomical image.

FIG. 4 illustrates a method for registering an intra-operative image to shape data from a medical instrument.

FIG. 5 illustrates a plurality of points forming a shape of the medical instrument.

FIG. 6 illustrates an intra-operative image of a patient anatomy.

FIG. 7 illustrates a plurality of points generated from the image of FIG. 6.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The techniques disclosed in this document may be used to register a medical instrument reference frame to an image frame of reference for an intra-operative anatomic image that includes an image of the medical instrument. Often, anatomical motion can result in intra-operative images that are too distorted to clearly isolate and segment the catheter and in medical instrument position data that is agitated. By representing the intra-operative image of the medical instrument as a cloud of points and the shape of the medical instrument (during the image capture period) as a cloud of points, point matching registration techniques, such as an iterative closest point technique, can be used to register the sensor point cloud and the image point cloud. The robustness of this registration technique allows the image frame of reference to be registered to the medical instrument frame of reference, despite data spread caused by patient anatomical motion.

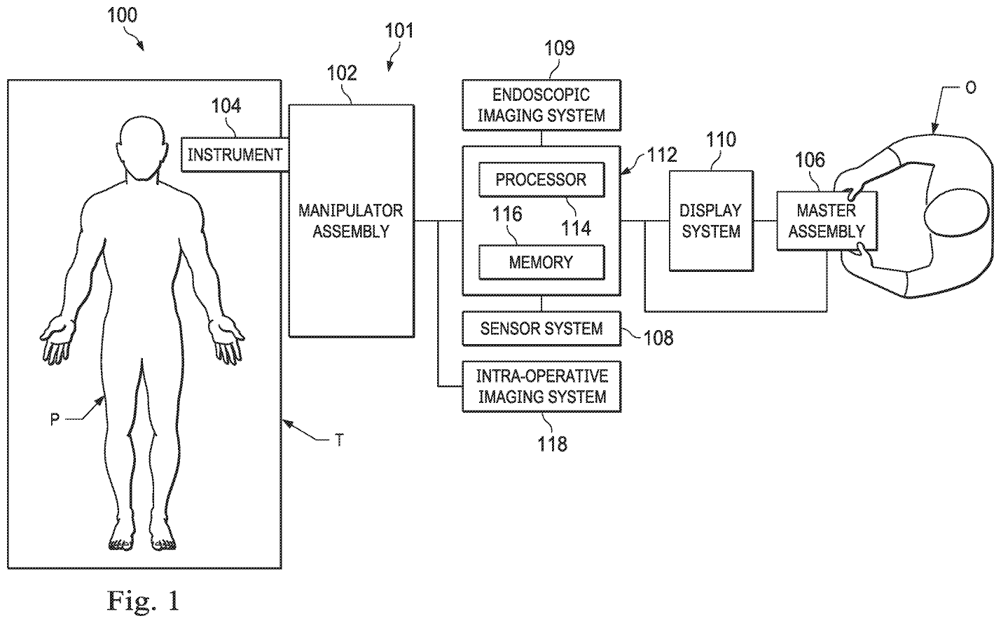

In some embodiments, the registration techniques of this disclosure may be used in an image-guided medical procedure performed with a teleoperated medical system as described in further detail below. As shown in FIG. 1, a tele-operated medical system 100 generally includes a manipulator assembly 102 for operating a medical instrument 104 in performing various procedures on a patient P positioned on a table T in a surgical environment 101. The manipulator assembly 102 may be teleoperated, non-teleoperated, or a hybrid teleoperated and non-teleoperated assembly with select degrees of freedom of motion that may be motorized and/or teleoperated and select degrees of freedom of motion that may be non-motorized and/or non-teleoperated. A master assembly 106, which may be inside or outside of the surgical environment 101, generally includes one or more control devices for controlling manipulator assembly 102. Manipulator assembly 102 supports medical instrument 104 and may optionally include a plurality of actuators or motors that drive inputs on medical instrument 104 in response to commands from a control system 112. The actuators may optionally include drive systems that when coupled to medical instrument 104 may advance medical instrument 104 into a naturally or surgically created anatomic orifice. Other drive systems may move the distal end of medical instrument 104 in multiple degrees of freedom, which may include three degrees of linear motion (e.g., linear motion along the X, Y, Z Cartesian axes) and in three degrees of rotational motion (e.g., rotation about the X, Y, Z Cartesian axes). Additionally, the actuators can be used to actuate an articulable end effector of medical instrument 104 for grasping tissue in the jaws of a biopsy device and/or the like.

Teleoperated medical system 100 also includes a display system 110 for displaying an image or representation of the surgical site and medical instrument 104 generated by a sensor system 108 and/or an endoscopic imaging system 109. Display system 110 and master assembly 106 may be oriented so operator O can control medical instrument 104 and master assembly 106 with the perception of telepresence.

In some embodiments, medical instrument 104 may include components for use in surgery, biopsy, ablation, illumination, irrigation, or suction. Optionally medical instrument 104, together with sensor system 108 may be used to gather (i.e., measure) a set of data points corresponding to locations within anatomic passageways of a patient, such as patient P. In some embodiments, medical instrument 104 may include components of the imaging system 109, which may include an imaging scope assembly or imaging instrument that records a concurrent or real-time image of a surgical site and provides the image to the operator or operator O through the display system 110. The concurrent image may be, for example, a two or three-dimensional image captured by an imaging instrument positioned within the surgical site. In some embodiments, the imaging system components that may be integrally or removably coupled to medical instrument 104. However, in some embodiments, a separate endoscope, attached to a separate manipulator assembly may be used with medical instrument 104 to image the surgical site. The imaging system 109 may be implemented as hardware, firmware, software or a combination thereof which interact with or are otherwise executed by one or more computer processors, which may include the processors of the control system 112.

The sensor system 108 may include a position/location sensor system (e.g., an electromagnetic (EM) sensor system) and/or a shape sensor system for determining the position, orientation, speed, velocity, pose, and/or shape of the medical instrument 104.

Teleoperated medical system 100 may also include control system 112. Control system 112 includes at least one memory 116 and at least one computer processor 114 for effecting control between medical instrument 104, master assembly 106, sensor system 108, endoscopic imaging system 109, and display system 110. Control system 112 also includes programmed instructions (e.g., a non-transitory machine-readable medium storing the instructions) to implement some or all of the methods described in accordance with aspects disclosed herein, including instructions for providing information to display system 110.

Control system 112 may optionally further include a virtual visualization system to provide navigation assistance to operator O when controlling medical instrument 104 during an image-guided surgical procedure. Virtual navigation using the virtual visualization system may be based upon reference to an acquired pre-operative or intra-operative dataset of anatomic passageways. The virtual visualization system processes images of the surgical site imaged using imaging technology such as computerized tomography (CT), magnetic resonance imaging (MRI), fluoroscopy, thermography, ultrasound, optical coherence tomography (OCT), thermal imaging, impedance imaging, laser imaging, nanotube X-ray imaging, and/or the like.

An intra-operative imaging system 118 may be arranged in the surgical environment 101 near the patient P to obtain images of the patient P during a medical procedure. The intra-operative imaging system 118 may provide real-time or near real-time images of the patient P. In some embodiments, the system 118 may be a mobile C-arm cone-beam CT imaging system for generating three-dimensional images. For example, the system 118 may be a DynaCT imaging system from Siemens Corporation of Washington, D.C., or other suitable imaging system. In other embodiments, the imaging system may use other imaging technologies including CT, MRI, fluoroscopy, thermography, ultrasound, optical coherence tomography (OCT), thermal imaging, impedance imaging, laser imaging, nanotube X-ray imaging, and/or the like.

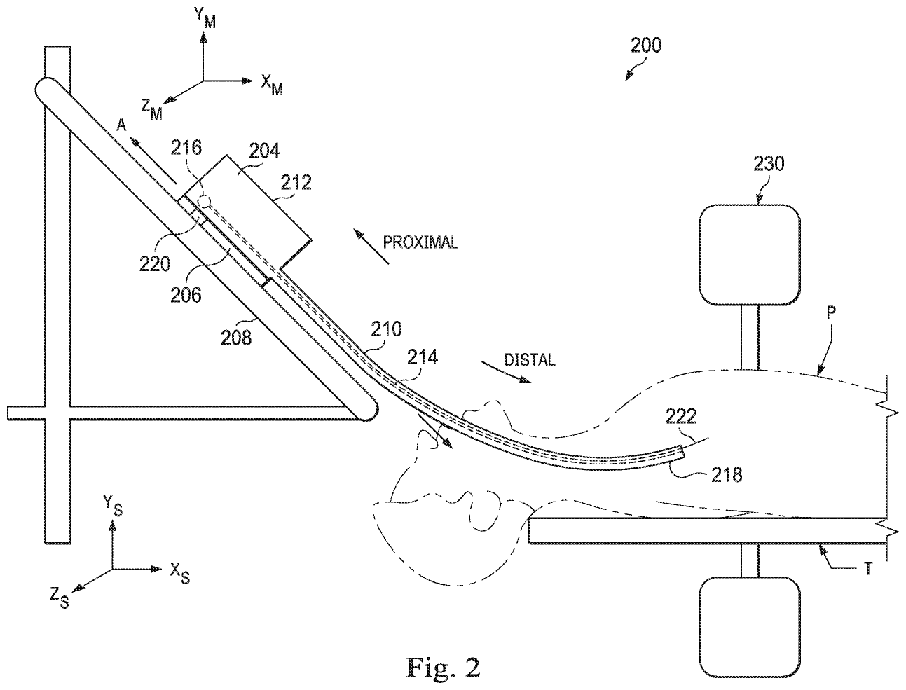

FIG. 2 illustrates a surgical environment 200 with a surgical frame of reference (X_{S}, Y_{S}, Z_{S}) in which the patient P is positioned on the table T. Patient P may be stationary within the surgical environment in the sense that gross patient movement is limited by sedation, restraint, and/or other means. Cyclic anatomic motion including respiration and cardiac motion of patient P may continue unless the patient is asked to hold his or her breath to temporarily suspend respiratory motion. Within surgical environment 200, a medical instrument 204 (e.g., the medical instrument 104), having a medical instrument frame of reference (X_{M}, Y_{M}, Z_{M}), is coupled to an instrument carriage 206. In this embodiment, medical instrument 204 includes an elongate device 210, such as a flexible catheter, coupled to an instrument body 212. Instrument carriage 206 is mounted to an insertion stage 208 fixed within surgical environment 200. Alternatively, insertion stage 208 may be movable but have a known location (e.g., via a tracking sensor or other tracking device) within surgical environment 200. In these alternatives, the medical instrument frame of reference is fixed or otherwise known relative to the surgical frame of reference. Instrument carriage 206 may be a component of a teleoperational manipulator assembly (e.g., teleoperational manipulator assembly 102) that couples to medical instrument 204 to control insertion motion (i.e., motion along an axis A) and, optionally, motion of a distal end 218 of the elongate device 210 in multiple directions including yaw, pitch, and roll. Instrument carriage 206 or insertion stage 208 may include actuators, such as servomotors, (not shown) that control motion of instrument carriage 206 along insertion stage 208.

In this embodiment, a sensor system (e.g., sensor system 108) includes a shape sensor 214. Shape sensor 214 may include an optical fiber extending within and aligned with elongate device 210. In one embodiment, the optical fiber has a diameter of approximately 200 In other embodiments, the dimensions may be larger or smaller. The optical fiber of shape sensor 214 forms a fiber optic bend sensor for determining the shape of the elongate device 210. In one alternative, optical fibers including Fiber Bragg Gratings (FBGs) are used to provide strain measurements in structures in one or more dimensions. Various systems and methods for monitoring the shape and relative position of an optical fiber in three dimensions are described in U.S. patent application Ser. No. 11/180,389 (filed Jul. 13, 2005) (disclosing “Fiber optic position and shape sensing device and method relating thereto”); U.S. patent application Ser. No. 12/047,056 (filed on Jul. 16, 2004) (disclosing “Fiber-optic shape and relative position sensing”); and U.S. Pat. No. 6,389,187 (filed on Jun. 17, 1998) (disclosing “Optical Fibre Bend Sensor”), which are all incorporated by reference herein in their entireties. Sensors in some embodiments may employ other suitable strain sensing techniques, such as Rayleigh scattering, Raman scattering, Brillouin scattering, and Fluorescence scattering. In some embodiments, the shape of the catheter may be determined using other techniques. For example, a history of the distal end pose of elongate device 210 can be used to reconstruct the shape of elongate device 210 over the interval of time.

As shown in FIG. 2, instrument body 212 is coupled and fixed relative to instrument carriage 206. In some embodiments, the optical fiber shape sensor 214 is fixed at a proximal point 216 on instrument body 212. In some embodiments, proximal point 216 of optical fiber shape sensor 214 may be movable along with instrument body 212 but the location of proximal point 216 may be known (e.g., via a tracking sensor or other tracking device). Shape sensor 214 measures a shape from proximal point 216 to another point such as distal end 18 of elongate device 210 in the medical instrument reference frame (X_{M}, Y_{M}, Z_{M}).

Elongate device 210 includes a channel (not shown) sized and shaped to receive a medical instrument 222. In some embodiments, medical instrument 222 may be used for procedures such as surgery, biopsy, ablation, illumination, irrigation, or suction. Medical instrument 222 can be deployed through elongate device 210 and used at a target location within the anatomy. Medical instrument 222 may include, for example, image capture probes, biopsy instruments, laser ablation fibers, and/or other surgical, diagnostic, or therapeutic tools. Medical instrument 222 may be advanced from the distal end 218 of the elongate device 210 to perform the procedure and then retracted back into the channel when the procedure is complete. Medical instrument 222 may be removed from proximal end of elongate device 210 or from another optional instrument port (not shown) along elongate device 210.

Elongate device 210 may also house cables, linkages, or other steering controls (not shown) to controllably bend distal end 218. In some examples, at least four cables are used to provide independent “up-down” steering to control a pitch of distal end 218 and “left-right” steering to control a yaw of distal end 218.

A position measuring device 220 provides information about the position of instrument body 212 as it moves on insertion stage 208 along an insertion axis A. Position measuring device 220 may include resolvers, encoders, potentiometers, and/or other sensors that determine the rotation and/or orientation of the actuators controlling the motion of instrument carriage 206 and consequently the motion of instrument body 212. In some embodiments, insertion stage 208 is linear, while in other embodiments, the insertion stage 208 may be curved or have a combination of curved and linear sections.

An intra-operative imaging system 230 (e.g., imaging system 118) is arranged near the patient P to obtain three-dimensional images of the patient while the elongate device 210 is extended within the patient. The intra-operative imaging system 230 may provide real-time or near real-time images of the patient P.

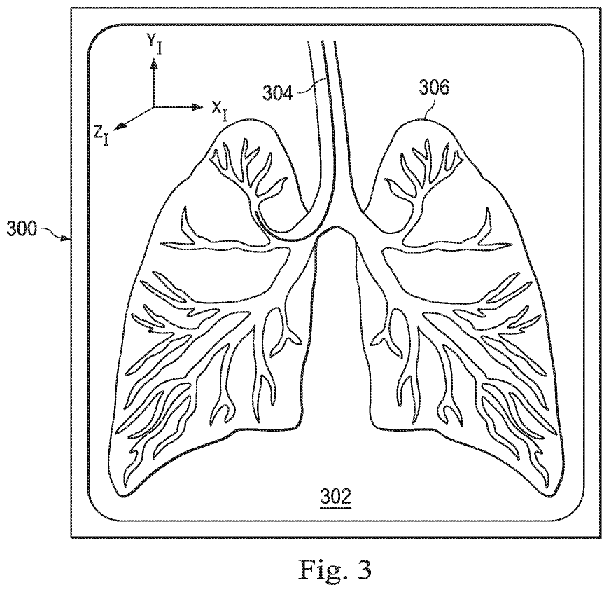

In some embodiments and with reference to FIG. 3, an image guided surgical procedure may be conducted in which the display system 300 (e.g., the display system 110) may display a virtual navigational image 302, having an image reference frame (X_{I}, Y_{I}, Z_{I}) in which an image 304 of the medical instrument 204 is registered (i.e., dynamically referenced) with an anatomic model 306 of patient P derived from pre-operative and/or intra-operative image data. In some embodiments, a virtual navigational image may present the physician O with a virtual image of the internal surgical site from a viewpoint of medical instrument 204. In some examples, the viewpoint may be from a distal tip of medical instrument 204. In some examples, medical instrument 204 may not be visible in the virtual image.

Generating the composite virtual navigational image 302 involves the registration of the image reference frame (X_{I}, Y_{I}, Z_{I}) to the surgical reference frame (X_{S}, Y_{S}, Z_{S}) and/or medical instrument reference frame (X_{M}, Y_{M}, Z_{M}). This registration may rotate, translate, or otherwise manipulate by rigid or non-rigid transforms points associated with the segmented instrument shape from the image data and points associated with the shape data from the instrument shape sensor 214. This registration between the image and instrument frames of reference may be achieved, for example, by using a point-based iterative closest point (ICP) technique as described in incorporated by reference U.S. Provisional Pat. App. Nos. 62/205,440 and 62/205,433, or another point cloud registration technique.

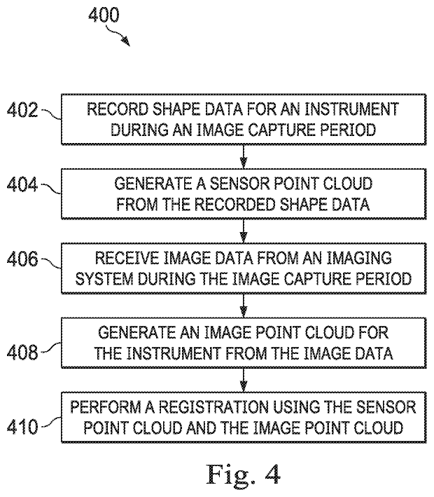

FIG. 4 illustrates a method 400 for registering an intra-operative image to shape data from a medical instrument. Often, anatomical motion can result in intra-operative anatomical image data that is too distorted to isolate and segment the medical instrument or instrument shape data that is too agitated to identify a stable shape during the image capture period. Despite the patient motion, the image frame of reference may be registered to the medical instrument frame of reference by registering an image point cloud representing the intra-operative image of the medical instrument to a sensor point cloud representing the shape of the medical instrument during the image capture period.

The method 400 is illustrated as a set of operations or processes 402 through 410 and is described with continuing reference to FIGS. 2, 3, and 5-7. Not all the illustrated processes may be performed in all embodiments of method 400. Additionally, one or more processes that are not expressly illustrated in FIG. 4 may be included before, after, in between, or as part of the processes 402 through 410. In some embodiments, one or more of the processes 402 through 410 may be performed by a control system 112 or may be implemented, at least in part, in the form of executable code stored on non-transitory, tangible, machine-readable media that when run by one or more processors (e.g., the processors 114 of control system 112) may cause the one or more processors to perform one or more of the processes.

At a process 402, shape data is recorded for an instrument (e.g., medical instrument 104, 204) during an image capture period of an imaging system (e.g., image system 230). In some embodiments, an image capture period corresponds to the time period during which the intra-operative imaging system 230 is activated to collect and record image data for the patient P. During that time period, shape data for the instrument 204, located in the patient P, may recorded. The shape data, gathered from shape sensor 214, may provide position information for the instrument 204 and a plurality of points along the instrument 204 in the medical instrument reference frame (X_{M}, Y_{M}, Z_{M}), which is known relative to the surgical reference frame (X_{S}, Y_{S}, Z_{S}). During the time period, the instrument 204 may be subject to no commanded movement, such as operator-commanded advancement or bending, but may be subject to anatomical motion from breathing, cardiac activity, or other voluntary or involuntary patient motion. For example, an image scan may be performed with the intra-operative image system 230 over an image capture period while the instrument 204 is positioned within the patient P anatomy, without being subject to commanded motion.

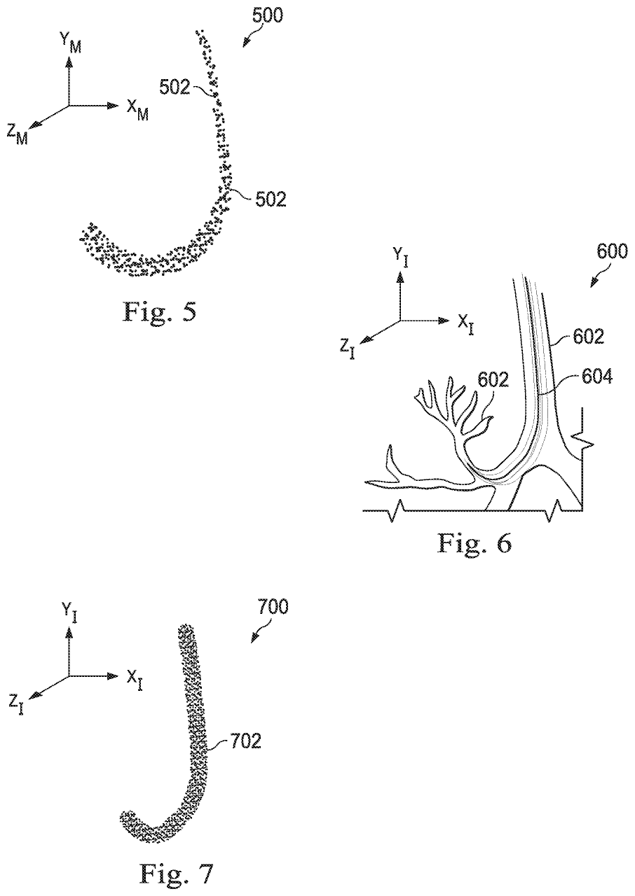

At a process 404, a sensor point cloud is generated from the recorded shape data. For example, and with reference to FIG. 5, a point cloud 500 is generated from the union of all recorded shapes of the shape sensor 214 during an image capture period of the intra-operative image system 230. Because the configuration, including shape and location, of the instrument 204 may change during the image capture period due to anatomical motion, the point cloud 500 is comprised of a plurality of points 502 representing the shape of the shape sensor 214 as the medical instrument 204 passively moves. The point cloud 500 may be two or three-dimensional and may be generated in the medical instrument reference frame (X_{M}, Y_{M}, Z_{M}).

At a process 406, image data is received from an imaging system during the image capture period. For example, and with reference to FIG. 6, image data 600 may be received from the intra-operative image system 230 during the image capture period and while the medical instrument 204 is positioned within the patient. The image data 600 may include graphical elements 602 representing the anatomical features of the patient P and graphical elements 604 representing the medical image 204.

At a process 408, an image point cloud may be generated for the medical instrument from the image data. For example, and with reference to FIG. 7, an image point cloud 700 may be generated by segmenting the graphical elements 604 representing the medical image 204 and filtering out the graphical elements 602 representing the anatomical features. During the segmentation process, pixels or voxels generated from the image data may be partitioned into segments or elements or be tagged to indicate that they share certain characteristics or computed properties such as color, density, intensity, and texture. The segments or elements may be converted to a cloud or set of points. Thus, the pixels or voxels associated by the medical instrument 204 may be segmented and converted into the cloud 700 comprising a plurality of points 702. The point cloud 700 may be two or three-dimensional and may be generated in the image reference frame (X_{I}, Y_{I}, Z_{I}). In some embodiments, less than all of the image data may be segmented and filtered. For example, if the distal end of the medical instrument 204 is parked near an anatomical area of interest, such as a tumor targeted for investigation or treatment, the data segmentation may be performed around the identified anatomical area of interest.

At a process 410, a registration may be performed between the image reference frame and the medical instrument reference frame or surgical reference frame by using a point cloud registration technique. For example, the sensor point cloud 500 in the medical instrument reference frame may be registered to the image point cloud 700 in the image reference frame. This registration may rotate, translate, or otherwise manipulate by rigid or non-rigid transforms the point clouds 500 and 700. The transforms may be six degrees-of-freedom (6DOF) transforms, such that the point clouds may be translated or rotated in any or all of X, Y, and Z and pitch, roll, and yaw. This registration between the image and instrument frames of reference may be achieved, for example, by using ICP or another point cloud registration technique.

To perform the registration using ICP or other point cloud registration techniques, the registration is seeded with known matching points in each point cloud 500, 700 and known orientation which may be determined from nearby points. Thus, a sensor seed point identified in the sensor point cloud 500 may be matched to an image seed point in the image cloud 700. In some embodiments, the sensor seed point and the image seed point correspond to the distal tip of the medical instrument. Another sensor seed point and an image seed point may correspond to a known proximal point. For example, the proximal point may be a known distance from the distal tip of the medical instrument. Knowing at least two seed points may provide orientation information for the registration. In some embodiments, the distal tip of the medical instrument may be enhanced in the image data by incorporating radiopaque features at the medical instrument distal tip. In some embodiments, the distal tip of the medical instrument in the image data may be identified by user input, such as receipt of a user indication of the distal point by a user input device such as a touchscreen or mouse. In some embodiments, the seeding of distal and proximal points may be performed by identifying the measured shape of the sensor in the image data. For example, a user may manually identify points in the sensor data corresponding to the medical instrument. The user may perform ray tracing with a pointing device (e.g., a mouse pointer) and intersect the ray tracing with the image data to identify pixels, voxels, or other image units that have a brightness value associated with the material of the medical instrument.

In some embodiments, a sensor envelope boundary may be determined that bounds the sensor point cloud 500, and an image envelope boundary may be determined that bounds the image point cloud 700. The registration of the point clouds may be performed by registering the sensory envelope boundary and the image envelope boundary.

With the image reference frame (X_{I}, Y_{I}, Z_{I}) registered to the medical instrument reference frame (X_{M}, Y_{M}, Z_{M}), the images displayed to the operator O on the display system 110, may allow the operator to more accurately steer the medical instrument, visualize a target lesion relative to the medical instrument, observe a view from the perspective of a distal end of the medical instrument, and/or improve efficiency and efficacy of targeted medical procedures.

In some embodiments, the intra-operative image data may be registered with pre-operative image data obtained by the same or a different imaging system. Thus, by registering the shape data to the intra-operative image data, the registration of the shape data to the pre-operative image data may also be determined. In some embodiments, an anatomic image generated from the intra-operative image data and/or the pre-operative image data may be displayed with the image of the instrument 204, derived from the instrument shape sensor data. For example, a model of the instrument 204 generated from the instrument shape data may be superimposed on the image of the patient anatomy generated from the image data.

In the description, specific details have been set forth describing some embodiments. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

Elements described in detail with reference to one embodiment, implementation, or application optionally may be included, whenever practical, in other embodiments, implementations, or applications in which they are not specifically shown or described. For example, if an element is described in detail with reference to one embodiment and is not described with reference to a second embodiment, the element may nevertheless be claimed as included in the second embodiment. Thus, to avoid unnecessary repetition in the following description, one or more elements shown and described in association with one embodiment, implementation, or application may be incorporated into other embodiments, implementations, or aspects unless specifically described otherwise, unless the one or more elements would make an embodiment or implementation non-functional, or unless two or more of the elements provide conflicting functions.

Any alterations and further modifications to the described devices, instruments, methods, and any further application of the principles of the present disclosure are fully contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. In addition, dimensions provided herein are for specific examples and it is contemplated that different sizes, dimensions, and/or ratios may be utilized to implement the concepts of the present disclosure. To avoid needless descriptive repetition, one or more components or actions described in accordance with one illustrative embodiment can be used or omitted as applicable from other illustrative embodiments. For the sake of brevity, the numerous iterations of these combinations will not be described separately. For simplicity, in some instances the same reference numbers are used throughout the drawings to refer to the same or like parts.

While some embodiments are provided herein with respect to medical procedures, any reference to medical or surgical instruments and medical or surgical methods is non-limiting. For example, the instruments, systems, and methods described herein may be used for non-medical purposes including industrial uses, general robotic uses, and sensing or manipulating non-tissue work pieces. Other example applications involve cosmetic improvements, imaging of human or animal anatomy, gathering data from human or animal anatomy, and training medical or non-medical personnel. Additional example applications include use for procedures on tissue removed from human or animal anatomies (without return to a human or animal anatomy) and performing procedures on human or animal cadavers. Further, these techniques can also be used for surgical and nonsurgical medical treatment or diagnosis procedures.

One or more elements in embodiments of this disclosure may be implemented in software to execute on a processor of a computer system such as control processing system. When implemented in software, the elements of the embodiments of the invention are essentially the code segments to perform the necessary tasks. The program or code segments can be stored in a processor readable storage medium or device that may have been downloaded by way of a computer data signal embodied in a carrier wave over a transmission medium or a communication link. The processor readable storage device may include any medium that can store information including an optical medium, semiconductor medium, and magnetic medium. Processor readable storage device examples include an electronic circuit; a semiconductor device, a semiconductor memory device, a read only memory (ROM), a flash memory, an erasable programmable read only memory (EPROM); a floppy diskette, a CD-ROM, an optical disk, a hard disk, or other storage device. The code segments may be downloaded via computer networks such as the Internet, Intranet, etc. Any of a wide variety of centralized or distributed data processing architectures may be employed. Programmed instructions may be implemented as a number of separate programs or subroutines, or they may be integrated into a number of other aspects of the systems described herein. In one embodiment, the control system supports wireless communication protocols such as Bluetooth, IrDA, HomeRF, IEEE 802.11, DECT, and Wireless Telemetry.

Note that the processes and displays presented may not inherently be related to any particular computer or other apparatus. Various general-purpose systems may be used with programs in accordance with the teachings herein, or it may prove convenient to construct a more specialized apparatus to perform the operations described. The required structure for a variety of these systems will appear as elements in the claims. In addition, the embodiments of the invention are not described with reference to any particular programming language. It will be appreciated that a variety of programming languages may be used to implement the teachings of the invention as described herein.

In some instances well known methods, procedures, components, and circuits have not been described in detail so as not to unnecessarily obscure aspects of the embodiments. This disclosure describes various instruments, portions of instruments, and anatomic structures in terms of their state in three-dimensional space. As used herein, the term “position” refers to the location of an object or a portion of an object in a three-dimensional space (e.g., three degrees of translational freedom along Cartesian x-, y-, and z-coordinates). As used herein, the term “orientation” refers to the rotational placement of an object or a portion of an object (three degrees of rotational freedom—e.g., roll, pitch, and yaw). As used herein, the term “pose” refers to the position of an object or a portion of an object in at least one degree of translational freedom and to the orientation of that object or portion of the object in at least one degree of rotational freedom (up to six total degrees of freedom). As used herein, the term “shape” refers to a set of poses, positions, or orientations measured along an object.

While certain exemplary embodiments of the invention have been described and shown in the accompanying drawings, it is to be understood that such embodiments are merely illustrative of and not restrictive on the broad invention, and that the embodiments of the invention not be limited to the specific constructions and arrangements shown and described, since various other modifications may occur to those ordinarily skilled in the art.

1. A system comprising:
a processor; and
a memory having computer readable instructions stored thereon, the computer readable instructions, when executed by the processor, cause the system to:
record shape data from a shape sensor for an instrument during an image capture period;
generate a sensor point cloud from the recorded shape data;
receive image data from an imaging system during the image capture period;
generate an image point cloud for the instrument from the image data; and
register the sensor point cloud to the image point cloud.

2. The system of claim 1, wherein the shape data includes position information for a plurality of points forming a shape of the shape sensor.

3. The system of claim 1, wherein the instrument is moving during the image capture period between a plurality of configurations and the sensor point cloud includes position information for a plurality of points along the shape sensor while the instrument is in the plurality of configurations.

4. The system of claim 1, wherein generating the image point cloud includes segmenting an image of the instrument from the image data.

5. The system of claim 4, wherein segmenting the image of the instrument from the image data includes identifying an area of interest in the image data based on the recorded shape data.

6. The system of claim 1, wherein registering the sensor point cloud to the image point cloud includes using an iterative closest point technique.

7. The system of claim 1, wherein registering the sensor point cloud to the image point cloud includes identifying a sensor seed point in the sensor point cloud and includes identifying an image seed point in the image point cloud.

8. The system of claim 7, wherein the sensor seed point and the image seed point correspond to a distal tip of the instrument.

9. The system of claim 7, wherein the sensor seed point and the image seed point correspond to a proximal area of the instrument.

10. The system of claim 7, wherein one of the sensor seed point or the image seed point is identified via a user input.

11. The system of claim 1, wherein the sensor point cloud includes a sensor envelope boundary and the image point cloud includes an image envelope boundary and wherein registering the sensor point cloud to the image point cloud includes registering the sensor and image envelope boundaries.

12. The system of claim 1, wherein the shape sensor includes an optical fiber shape sensor extending within the instrument.

13. The system of claim 1 further comprising the imaging system.

14. The system of claim 1 further comprising the instrument.

15. A non-transitory machine-readable medium comprising a plurality of machine-readable instructions which when executed by one or more processors associated with a computer-assisted medical system device are adapted to cause the one or more processors to perform a method comprising:
recording shape data from a shape sensor for an instrument during an image capture period;
generating a sensor point cloud from the recorded shape data;
receiving image data from an imaging system during the image capture period;
generating an image point cloud for the instrument from the image data; and
registering the sensor point cloud to the image point cloud.

16. The non-transitory machine-readable medium claim 15, wherein the shape data includes position information for a plurality of points forming a shape of the shape sensor.

17. The non-transitory machine-readable medium claim 15, wherein the instrument is moving during the image capture period between a plurality of configurations and the sensor point cloud includes position information for a plurality of points along the shape sensor while the instrument is in the plurality of configurations.

18. The non-transitory machine-readable medium claim 15, wherein generating the image point cloud includes segmenting an image of the instrument from the image data.

19. The non-transitory machine-readable medium claim 18, wherein segmenting the image of the instrument from the image data includes identifying an area of interest in the image data based on the recorded shape data.

20. The non-transitory machine-readable medium claim 15, wherein registering the sensor point cloud to the image point cloud includes using an iterative closest point technique.

21-25. (canceled)
